(19) United States
(12) Patent Application Publication
(10) Pub. No.: US 2009/0122090 A1
(43) Pub. Date: May 14, 2009

(54) Data line driving circuit, electro-optic device, and electronic apparatus

(75) Inventors: Hiroaki Jo, Suwa-shi (JP); Toshiyuki Kasai, Okaya-shi (JP); Takeshi Nozawa, Suwa-shi (JP)

Correspondence Address: OLIFF & BERRIDGE, PLC, P.O. BOX 320850, ALEXANDRIA, VA, 22320-4850, US

(73) Assignee: SEIKO EPSON CORPORATION, Tokyo (JP)

(21) Appl. No.: 12/318,904

(22) Filed: Jan. 12, 2009

Related U.S. Application Data
(62) Division of application No. 11/023,455, filed on Dec. 29, 2004.

(30) Foreign Application Priority Data
Jan. 5, 2004 (JP) 2004-000351
Jan. 5, 2004 (JP) 2004-000352
Jan. 5, 2004 (JP) 2004-000360
Nov. 22, 2004 (JP) 2004-336982

(51) Int. Cl. G09G 5/10

(52) U.S. Cl. 345/690

(57) ABSTRACT

To adjust brightness of an electro-optic device for each pixel. A data line driving circuit includes a DAC for generating a gray-scale current according to gray-scale data representing gray-scales of pixels, and a DAC for generating a correction current for correcting the brightness of the pixels. The data line driving circuit generates a voltage according to a current obtained by adding the correction current generated in the DAC to the gray-scale current in the DAC and applies the generated voltage to each data line.

This is a Divisional of application Ser. No. 11/023,455 filed Dec. 29, 2004. The entire disclosure of the prior application is hereby incorporated by reference herein in its entirety.

### BACKGROUND

The present invention relates to a technique for adjusting brightness of pixels of an electro-optic device.

As a driving circuit for driving pixel circuits of an electro-optic device such as an organic electro luminescence display, a driving circuit using a digital-analog conversion circuit (hereinafter, referred to as ‘DAC’) of the current addition type has been widely known. Since the DAC of the current addition type can be configured with the number of wires less than that of a DAC of voltage output type, it has an advantage in that this can easily cope with multi-gray scaling of the electro-optic device. Many techniques for the DAC of current addition have been proposed (See Patent Documents 1, 2 and 3, for example, which are listed below).

Patent Document 1 discloses a DAC of the current addition type for selecting and adding currents from a plurality of current sources according to gray-scale data. In this document, for the purpose of reducing the number of wires, the gray-scale data has n bits (n is an integer, n≧1), and the amount of current supplied form the current sources has a ratio of 1:2:4: . . . :2ⁿ⁻¹, for example, according to bits of the gray-scale data. A DAC of the current addition type disclosed in Patent Document 2 drives pixels using charges stored in capacitors when turning on/off a plurality of current sources connected to the capacitors according to gray-scale data, for the purpose of reducing the number of capacitors and hence the size of circuit. A DAC of the current addition type disclosed in Patent Document 3 adjusts a voltage to have a value within a certain range when converting currents added according to gray-scale data to the voltage, for the purpose of alleviating an offset of voltage in each channel.

[Patent Document 1] Japanese Unexamined Patent Application Publication No. 5-216439

[Patent Document 2] Japanese Unexamined Patent Application Publication No. 8-95522

[Patent Document 3] Japanese Unexamined Patent Application Publication No. 2002-26729

### SUMMARY

However, in an organic EL display using a pixel circuit of voltage driving type, a voltage according to gray-scale data is applied to driving transistors provided in the pixel circuit, and organic EL elements emit light with brightness according to the gray-scale data by supplying a current according to the voltage to the organic EL elements. An example of this pixel circuit is shown in FIG. 3. A relationship between a current I flowing between a source electrode and a drain electrode of a transistor 162 shown in the figure and a gate voltage Vgs of the transistor 162 is expressed as Equation 1 below.

I=(1/2)β(Vgs−Vth)² (1)

Where, β is a gain coefficient, and Vth is a threshold voltage.

In the above Equation 1, the current I is uniquely determined by the gate voltage Vgs if β and Vth have an equivalent value for all driving transistors. In actuality, however, since the driving transistors have different gain coefficients β and different threshold voltages Vth, they have different currents, which result in a deviation in brightness. In addition, even if a pixel circuit having a function to compensating the threshold voltage Vth is employed, the deviation of brightness can not be overcome due to the deviation of the gain coefficient β. In addition, any of the above-mentioned Patent Documents does not disclose a solution to overcome this problem.

On the other hand, there are also problems described below. There is a case where driving transistors provided in a pixel circuit are different in manufacture process from transistors provided in a driving circuit. In most cases, thin film transistors (TFT) are used in the pixel circuit, and an integrated circuit (IC) composed of metal oxide semiconductor field effect transistors (MOSFET) is used in the driving circuit. Transistors having different manufacture processes have different gain coefficients P and different threshold voltages Vth in Equation 1. When the transistors has the different gain coefficients p and the different threshold voltages Vth, currents different from desired currents according to gray-scale data are generated in the driving transistors of the pixel circuit. This causes a problem in that the organic EL elements cannot emit light with desired brightness. Any of the above-mentioned Patent Documents does not disclose a solution to overcome this problem.

The present invention has been made in view of these problems, and it is an object of the present invention to provide a technique for adjusting brightness of an electro-optic device for each pixel. It is another object of the present invention to provide a technique for emitting light from pixels with desired brightness even if characteristics of driving transistors of a pixel circuit are different from those of transistors of a driving circuit.

In order to achieve the above-mentioned objects, the present invention provides a data line driving circuit for driving a plurality of data lines in an electro-optic device including pixels formed at intersections of one or a plurality of scanning lines and the plurality of data lines, and a scanning line driving circuit for sequentially selecting the plurality of scanning lines and supplying selection signals to the selected scanning lines, the data line driving circuit comprising: a gray-scale current generating means for generating a gray-scale current according to gray-scale data representing gray-scales of pixels formed on corresponding scanning lines during a period when the selection signals are supplied to the scanning lines, a correction current generating means for generating a correction current for correcting the brightness of the pixels, a current-voltage converting means for generating a voltage according to a current obtained by adding the gray-scale current generated by the gray-scale current generating means to the correction current generated by the correction current generating means, and a means for applying the voltage generated by the current-voltage converting means to the data lines.

With this configuration, the gray-scale current generating means generates the gray-scale current, and the correction current generating means generates the correction current for correcting the brightness of the pixels. In addition, the data line driving circuit generates the voltage according to the current obtained by adding the correction current to the gray-scale current and applies the generated voltage to the data lines.

Accordingly, brightness of the electro-optic device can be adjusted for each pixel.

Preferably, the correction current generating means generates the correction current based on correction data for correcting the brightness of each pixel. With this configuration, since the correction current is generated based on the correction data, the adjustment of brightness can be properly conducted.

Preferably, the gray-scale current generating means is a digital-analog conversion circuit of the current addition type for generating a plurality of element currents and generating the gray-scale current by adding element currents to each other, which are selected from the plurality of element currents based on the gray-scale data. With this configuration, since the gray-scale current is generated by adding the plurality of element currents each other, the adjustment of brightness can be properly conducted.

Preferably, the correction current generating means is a digital-analog conversion circuit of the current addition type for generating a plurality of element currents and the correction current by adding element currents selected from the plurality of element currents based on the gray-scale data. With this configuration, since the correction current is generated by adding the plurality of element currents each other, the adjustment of brightness can be properly conducted.

Preferably, the data line driving circuit further comprises storing means for storing the correction data, and the correction current generating means reads the correction data stored in the storing means and generates the correction current according to the correction data. With this configuration, since the correction data stored in the storing means is used, the adjustment of brightness can be efficiently conducted.

Preferably, a plurality of correction current generating means are provided to correspond to the same number of data lines. With this configuration, the adjustment of brightness can be conducted every pixel.

Preferably, the data line driving circuit further comprises a current source and a reference voltage generating means for generating a voltage using a current supplied from the current source, the gray-scale current generating means generates the gray-scale current using the voltage generated by the reference voltage generating means, and the correction current generating means generates the correction current using the voltage generated by the reference voltage generating means. In addition, preferably, the amount of current generated by the current source is adjustable.

Preferably, the correction data is gray-scale data belonging to a certain gray-scale range. With this configuration, the brightness of pixels is adjustable every gray-scale range.

In addition, in order to achieve the above-mentioned objects, the present invention provides a data line driving circuit for driving a plurality of data lines in an electro-optic device including pixels formed at intersections of one or a plurality of scanning lines and the plurality of data lines, and a scanning line driving circuit for sequentially selecting the plurality of scanning lines and supplying selection signals to the selected scanning lines, the data line driving circuit comprising: a reference voltage generating means for generating a reference voltage to be used for generating a gray-scale current, a correction means for correcting the reference voltage generated by the reference voltage generating means, a gray-scale current generating means for generating a gray-scale current using the reference voltage corrected by the correction means, a current-voltage converting means for generating a voltage according to the gray-scale current generated by the gray-scale current generating means, and a means for applying the voltage generated by the current-voltage converting means to the data lines.

With this configuration, the reference voltage generated by the reference voltage generating means is corrected by the correction means. The gray-scale current generating means generates the gray-scale current using the reference voltage corrected by the correction means. The current-voltage converting means generates the voltage according to the gray-scale current. The data line driving circuit applies the generated voltage to the data lines.

Accordingly, a dynamic range of brightness of the electro-optic device can be adjusted for each pixel.

Preferably, the correction means corrects the reference voltage based on correction data for correcting the brightness of each pixel. With this configuration, since the reference voltage is corrected based on the correction data, the adjustment of brightness can be properly conducted.

Preferably, the gray-scale current generating means is a digital-analog conversion circuit of the current addition type for generating a plurality of element currents using the reference voltage corrected by the correction means and for generating the gray-scale current by adding element currents selected from the plurality of element currents based on gray-scale data representing gray-scales of the pixels. With this configuration, since the gray-scale current is generated by adding the plurality of element currents each other, the adjustment of brightness can be properly conducted.

Preferably, the correction means is a digital-analog conversion circuit of the current addition type for generating a plurality of element currents using the reference voltage generated by the reference voltage generating means, and generating a voltage according to a current obtained by adding element currents to each other, which are selected from the plurality of element currents based on the correction data. With this configuration, since the voltage according to the current obtained by adding the plurality of element currents each other is generated, the adjustment of brightness can be properly conducted.

Preferably, the data line driving circuit further comprises storing means for storing the correction data, and the correction means reads the correction data stored in the storing means and corrects the reference voltage based on the correction data. With this configuration, since the correction data stored in the storing means is used, the adjustment of brightness can be efficiently conducted.

Preferably, the correction means is provided in plural according to the data lines. With this configuration, the adjustment of brightness can be conducted every pixel.

Preferably, the reference voltage generating means includes a current source for adjusting the amount of current and generates the reference voltage using a current supplied from the current source. With this configuration, since the amount of current used to generate the reference voltage is adjustable, a dynamic range of the gray-scale current is adjustable.

In addition, the present invention provides a data line driving circuit comprising: a reference voltage generating means for generating a reference voltage to be used for generating a gray-scale current, a gray-scale current generating means for generating a gray-scale current using the reference voltage generated by the reference voltage generating means, a correction means for correcting the gray-scale current generated by the gray-scale current generating means, a current-voltage converting means for generating a voltage according to the gray-scale current corrected by the correction means, and a means for applying the voltage generated by the current-voltage converting means to the data lines. With this configuration, since the gray-scale current generated by the gray-scale current generating means is corrected, a dynamic range of brightness of the electro-optic device can be adjusted for each pixel.

In addition, in order to achieve the above-mentioned objects, the present invention provides a data line driving circuit for driving a plurality of data lines in an electro-optic device including pixel circuits formed at intersections of one or a plurality of scanning lines and the plurality of data lines and having a driving transistor for generating a current according to an applied voltage and an element to be driven by the current supplied from the driving transistor, and a scanning line driving circuit for sequentially selecting the plurality of scanning lines and supplying selection signals to the selected scanning lines, the data line driving circuit comprising: a gray-scale current generating circuit for generating a gray-scale current based on gray-scale data representing gray-scales of pixels formed on corresponding scanning lines during a period when the selection signals are supplied to the scanning lines, and a current to voltage converting circuit including a first transistor having a drain electrode and a gate electrode shorted therebetween, the gate electrode being connected to a gate electrode of the driving transistor via one of the data lines, for generating a voltage according to the gray-scale current by supplying the gray-scale current generated by the gray-scale current generating circuit to the first transistor.

With this configuration, the current to voltage generating circuit generates the voltage according to the gray-scale current by supplying the gray-scale current generated by the gray-scale current generating circuit to the first transistor, and applies the voltage to the data lines. Accordingly, even if characteristics of a driving transistor of the pixel circuit are different from those of a transistor of the driving circuit, since an adjustment according to a difference between their characteristics can be conducted, the pixels can emit light with desired brightness.

Preferably, the data line driving circuit further comprises a reference voltage generating circuit for generating a reference voltage to be used for generating the gray-scale current, and the gray-scale current generating circuit generates the gray-scale current using the reference voltage generated by the reference voltage generating circuit. Preferably, the reference voltage generating circuit includes a second transistor having a drain electrode and a gate electrode shorted therebetween with each other and a current source for adjusting the amount of current, and generates the reference voltage by supplying a current generated by the current source to the second transistor. With this configuration, since the reference voltage is adjustable, the amount of gray-scale current is adjustable. Accordingly, the pixels can emit light with desired brightness.

Preferably, in the data line driving circuit, when the threshold voltage of the first transistor is lower than the threshold voltage of the driving transistor, the power supply voltage at an upper side of the first transistor is lower than the power supply voltage at an upper side of the driving transistor by the threshold voltage difference between the first transistor and the driving transistor, and when the threshold voltage of the first transistor is higher than the threshold voltage of the driving transistor, the power supply voltage at the upper side of the first transistor is higher than the power supply voltage at the upper side of the driving transistor by the threshold voltage difference between the first transistor and the driving transistor. With this configuration, even if the threshold voltage of the driving transistor of the pixel circuit is different from that of the transistor of the current to voltage converting circuit, the pixels can emit light with desired brightness.

Preferably, the first transistor includes a plurality of transistors having gate electrodes connected in common, and a switch for shorting the gate electrodes and drain electrodes of the plurality of transistors and connecting the drain electrodes in common, and the switch is switched on/off based on data prepared in advance. With this configuration, since current capability of the first transistor is adjustable, the pixels can emit light with desired brightness.

Preferably, the gray-scale current generating circuit is a digital-analog conversion circuit of the current addition type for generating a plurality of element currents and generating the gray-scale current by adding element currents to each other, which are selected from the plurality of element currents based on the gray-scale data. With this configuration, since the gray-scale current is generated by adding the plurality of element currents each other, the adjustment of brightness can be properly conducted.

Preferably, the data line driving circuit further comprises a buffer circuit for buffering the voltage generated by the current-voltage conversion circuit and outputting the buffered voltage. With this configuration, a stable voltage can be outputted.

The data line driving circuit of the present invention is quite adapted to electro-optic device for driving pixels formed at intersections of one or a plurality of scanning lines and a plurality of data lines. Also, the electro-optic device is preferably provided in electronic device.

### BRIEF DESCRIPTION OF THE DRAWINGS

FIG. 1 is a diagram illustrating an electro-optic device 100 according to a first embodiment;

FIG. 2 is a diagram illustrating signals supplied from a scanning line driving circuit 21;

FIG. 3 is a diagram illustrating an example of the configuration of a pixel circuit 16;

FIG. 4 is a diagram illustrating the configuration of a data line driving circuit 22;

FIG. 5 is a diagram illustrating the configuration of a DAC 222 and a reference voltage generating circuit 223;

FIG. 6 is a diagram illustrating a DAC 35;

FIG. 7 is a diagram illustrating the configuration of a DAC 222 and a reference voltage generating circuit 223;

FIG. 8 is a diagram illustrating a DAC 45;

FIG. 9 is a diagram illustrating the configuration of a data line driving circuit 22;

FIG. 10 is a diagram illustrating the configuration of a DAC 222, a reference voltage generating circuit 223, and a current-voltage conversion circuit 224;

FIG. 11 is a diagram illustrating a reference voltage generating circuit 56;

FIG. 12 is a diagram illustrating a current-voltage conversion circuit 57;

FIG. 13 is a diagram illustrating a configuration including a buffer circuit 58;

FIG. 14 is a diagram illustrating the configuration of a pixel circuit 17;

FIG. 15 is a diagram illustrating the operation of a pixel circuit 17; and

FIG. 16 is a diagram showing a personal computer using an electro-optic device 100.

### DETAILED DESCRIPTION OF EMBODIMENTS

### First Embodiment

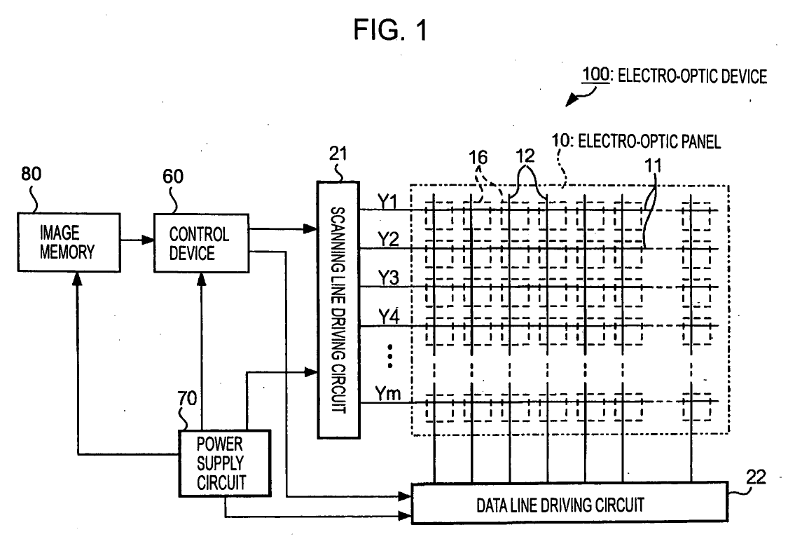

Now, a first embodiment of the present invention will be described. FIG. 1 is a diagram illustrating the configuration of an electro-optic device 100 according to the first embodiment. In this embodiment, an example where the present invention is applied to an organic EL display will be described.

An electro-optic panel 10 has m scanning lines and 11 and n data lines 12. The scanning lines 11 are perpendicular to the data lines 12, respectively, and a pixel circuit 16 is provided at each of intersections of the scanning lines 11 and the data lines 12. An image memory 80 stores gray-scale data supplied to a data line driving circuit 22. A control device 60 is composed of a central processing unit (CPU), a random access memory (RAM), a read only memory (ROM), etc., and the CPU controls various components of the electro-optic device 100 by executing programs loaded in the ROM. A power supply circuit 70 is a circuit for supplying power to the various components of the electro-optic device 100.

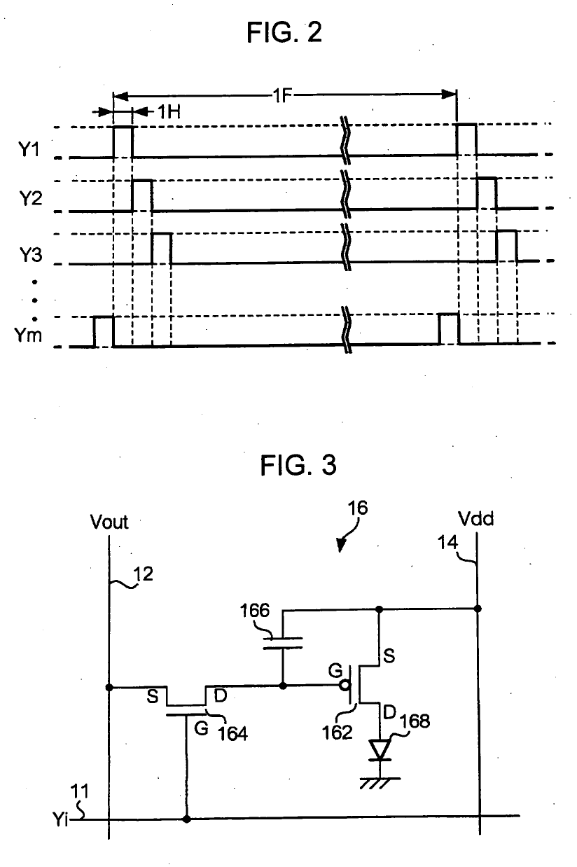

A scanning line driving circuit 21 is a circuit for supplying a scan signal to each scanning line 11. FIG. 2 is a diagram illustrating signals supplied from the scanning line driving circuit 21. More specifically, the scanning line driving circuit 21 sequentially selects the scanning lines 11 one by one every one horizontal scan period (1 H) from a start point of a vertical scan period (1 F) and supplies a scan signal (selection signal) of an active level (H level) to the selected scanning line 11 and another scan signal (non-selection signal) of an inactive level (L level) to the other scanning lines 11. Here, a scan signal supplied to an i-th (i=1, 2, . . . , m) row scanning line is denoted by Yi.

On the other hand, the data line driving circuit 22 is a circuit for applying a voltage according to gray data to each pixel circuit 16 via the data lines 12. The data line driving circuit 22 will be described in detail later.

Now, the pixel circuits 16 will be described. FIG. 3 is a diagram illustrating an example of the configuration of the pixel circuits 16. Although only a pixel circuit 16 provided at an intersection between an i-th row scanning line 11 and a j-th (j=1, 2, . . . , n) column data line 12 is shown in the figure, the other pixel circuits 16 have the same configuration. In the figure, a transistor 164 is an n-channel transistor acting as a switching transistor. The transistor 164 has a gate electrode (hereinafter, abbreviated as ‘gate’) connected to the scanning line 11, a source electrode (hereinafter, abbreviated as ‘source’) connected to the data line 12, and a drain electrode (hereinafter, abbreviated as ‘drain’) connected to a gate of a transistor 162 and one end of a capacitor 166. The other end of the capacitor 166 is connected to a power line 14 to which an power supply voltage Vdd at an upper side is applied. The transistor 162 is a p-channel transistor acting as a driving transistor. The transistor 162 has a source connected to the power line 14 and a drain connected to an anode of an organic EL element 168. A cathode of the organic EL element 168 is connected to an power supply voltage Gnd at a lower side. An organic EL layer is sandwiched between the anode and the cathode of the organic EL element 168.

Next, operation of the pixel circuit 16 provided at the intersection between the i-th row scanning line 11 and the j-th column data line 12 will be described. When the i-th row scanning line 11 is selected and the scan signal Yi goes into an H level, the transistor 164 is turned on and a voltage Vout is applied to the gate of the transistor 162. Then, a current Iout corresponding to the voltage Vout flows between the source and the drain of the transistor 162, and accordingly, the organic EL element 168 emits light with brightness corresponding to the current Iout. At this time, charges corresponding to the voltage Vout are accumulated in the capacitor 166.

Subsequently, when the selection of the i-th row scanning line is released and the scan signal Yi goes into an L level, the transistor 164 is turned off. However, since a gate voltage of the transistor 162 is maintained by the capacitor 166, the current Iout having the same magnitude as the current Iout flowing when the transistor 164 is turned on continues to flow to the organic EL element 168. On this account, although the selection of the i-th row scanning line 11 is released, the organic EL element 168 continues to emit light with brightness corresponding to the current Iout flowing when the i-th row scanning line 11 is selected.

The operation as described above is performed at all pixel circuits 16 provided at intersections of the i-th row scanning line 11 and each data line 12. In addition, as the scanning lines 11 are selected sequentially, the same operation is performed at all pixel circuits 16, thereby displaying an image of one frame. In addition, the display of the image of one frame is repeated every one vertical scan period.

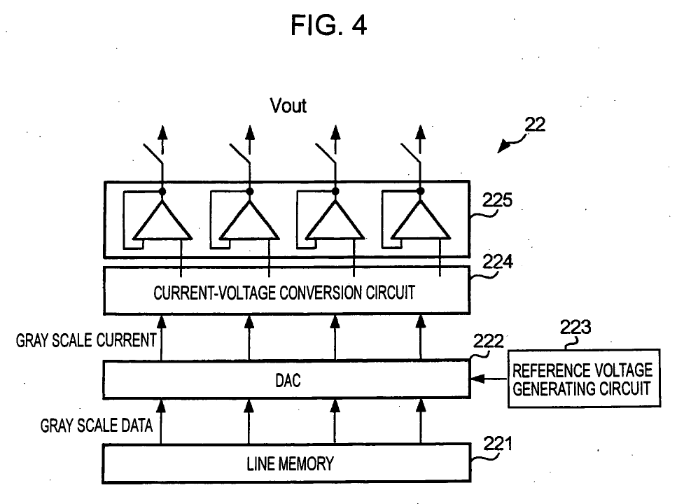

Next, the data line driving circuit 22 will be described. FIG. 4 is a diagram illustrating the configuration of the data line driving circuit 22. A line memory 221 stores gray-scale data corresponding to pixels provided at intersections of the scanning line 11 selected by the scanning line driving circuit 21 and each data line 12. The gray-scale data is supplied from the image memory 80. A reference voltage generating circuit 223 generates a reference voltage and applies it to a DAC 222. The DAC 222 generates a current according to the gray-scale data of respective pixel circuits, which is supplied from the line memory 221, and supplies the generated current to a current-voltage conversion circuit 224. The current-voltage conversion circuit 224 generates a voltage (data signal) according to the supplied current and outputs it to each data line 12 via a buffer circuit 225.

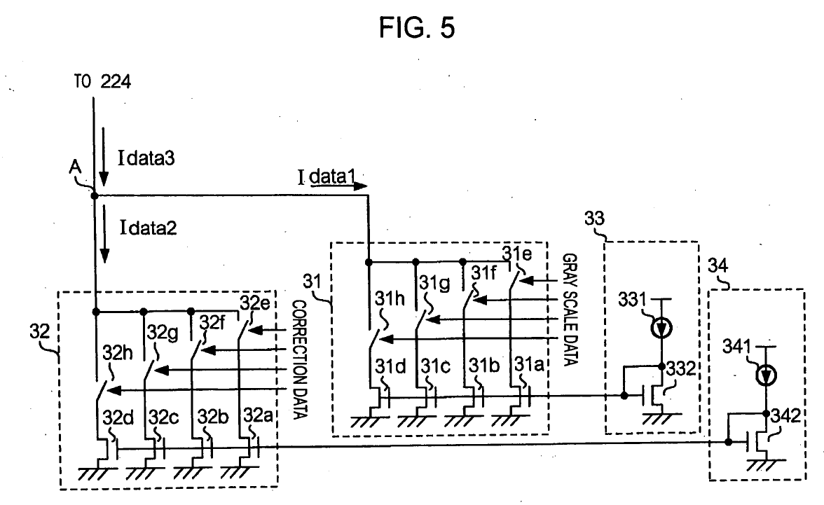

Next, the DAC 222 will be described in more detail. FIG. 5 is a diagram illustrating the configuration of the DAC 222 and the reference voltage generating circuit 223. The DAC 222 is composed of n DACs 31 and n DACs 32, which correspond to each data line 12. The DAC 31 is a DAC for generating a gray-scale current based on the gray-scale data and the DAC 32 is a DAC for generating a correction current to be added to the current generated by the DAC 31.

The reference voltage generating circuit 223 is composed of n reference voltage generating circuits 33 corresponding to the DACs 31, respectively, and n reference voltage generating circuits 34 corresponding to the DACs 32, respectively. The reference voltage generating circuit 33 is a circuit for applying the reference voltage to the DAC 31, and the reference voltage generating circuit 34 is a circuit for applying the reference voltage to the DAC 32.

In FIG. 5, for the purpose of avoiding the complexity of the figure, only the DAC 31, the DAC 32, the reference voltage generating circuit 33, and the reference voltage generating circuit 34, which correspond to the j-th column data line 12, are shown.

Next, the configuration of the DAC 31 and the reference voltage generating circuit 33 will be described in more detail. The DAC 31 includes a transistor 31a, a transistor 31b, a transistor 31c, and a transistor 31d. All of the transistors 31a to 31d are an n-channel transistor and have sources grounded. In addition, drains of the transistors 31a to 31d are connected to one ends of switches 31e, 31f, 31g, and 31h, respectively. All of the other ends of the switches 31e to 31h are connected to a terminal A. The reference voltage generating circuit 33 includes a constant current source 331 and a transistor 332. The transistor 332 is an n-channel transistor and has a drain connected to the constant current source 331 and a source grounded. Here, the drain and a gate of the transistor 332 are shorted therebetween, thereby forming a diode junction. In addition, a current mirror circuit is formed by connection between the gate of the transistor 332 and gates of the transistors 31a to 31d. Accordingly, a gate voltage having the same magnitude as a gate voltage of the transistor 332 is applied to the gates of the transistors 31a to 31d, and accordingly, a current according to the gate voltage (element current) flows between the sources and the drains of the transistors 31a to 31d.

Here, a size ratio of channels of the transistors 31a to 31d will be described. The transistors 31a to 31d have the same channel length L1 and different channel widths. Assuming the channel widths of the transistors 31a, 31b, 31c and 31d are Wa, Wb, Wc, and Wd, respectively, a ratio between them, that is, Wa:Wb:Wc:Wd=1:2:4:8. A gain coefficient β of a transistor is expressed as μCW/L. Where, μ is mobility of carriers, C is a gate capacitance, W is a channel width, and L is a channel length. Accordingly, a current flowing through the transistor is in proportion to the channel width. Accordingly, when the same gate voltage is applied to the transistors 31a to 31d, a ratio of current flowing through the transistors 31a, 31b, 31c and 31d is 1:2:4:8.

In this embodiment, the gray-scale data is composed of binary numbers of 4 bits. When the gray-scale data is supplied to the DAC 31 via the line memory 221, the switches 31e to 31h are switched on/off according to the gray-scale data. In more detail, each bit of the gray-scale data corresponds to the switches 31e, 31f, 31g, and 31h, starting from the least significant bit. For example, if the least significant bit is 0, the switch 31e is switched off, and if the least significant bit is 1, the switch 31e is switched on. In this way, the switches 31e to 31h are switched on/off based on the gray-scale data, and currents flow through transistors corresponding to switches switched on. Accordingly, a total current obtained by adding individual currents flowing through the respective transistors can has current values of 16 steps including zero, and a gray-scale current Idata1 having a magnitude according to the gray-scale data is outputted.

The DAC 32 has the same configuration as the DAC 31 and the reference voltage generating circuit 34 has the same configuration as the reference voltage generating circuit 33. In FIG. 5, reference numerals of elements of the DAC 32 are to replace portions ‘31’ in the reference numerals of elements of the DAC 31 as ‘32’. In addition, reference numerals of elements of the reference voltage generating circuit 34 are to replace portions ‘33’ in the reference numerals of elements of the reference voltage generating circuit 33 as ‘34’.

However, the DAC 32 is inputted with correction data, instead of the gray-scale data. Input/output characteristics of an organic EL element are changed depending on environmental conditions such as temperature and external light, and change of the organic EL element itself with time. In addition, deviations of the input/output characteristics occur due to deviations of characteristics of the driving transistors provided in the pixel circuits 16. Accordingly, in consideration of the variation of environmental conditions or the change of the organic EL element itself with time, there rises a need to correct peak brightness of the organic EL element or gradient data of gamma correction for each pixel. Data used to conduct such a correction is the correction data in this embodiment. The correction data is composed of binary numbers of 4 bits and has data values of 16 steps including zero.

In addition, the correction data may be gray-scale data belonging to a certain gray-scale range. The brightness of pixels can be adjusted for each gray-scale range by using such correction data.

In addition, the correction data may be stored in the image memory together the gray-scale data.

Now, operation of the electro-optic device 100 as configured above will be described. The DAC 31 uses the reference voltage generated in the reference voltage generating circuit 33 and generates the gray-scale current Idata1 according to the gray-scale data. The DAC 32 uses the reference voltage generated in the reference voltage generating circuit 34 and generates a correction current Idata2 according to the correction data. Also, the gray-scale current Idata1 and the correction current Idata2 are added each other at a terminal A to generate a current Idata3.

The current Idata3 is supplied to the current-voltage conversion circuit 224, which then generates a voltage Vout according to the supplied current Idata3 and outputs the voltage Vout to the buffer circuit 225. The buffer circuit 225 applies the voltage Vout to each data line 12. When the voltage Vout is applied to the data line 12, a current Iout according to the voltage Vout is supplied to the organic EL element provided in the pixel circuit 16 according to the operation as described above, and accordingly, the organic EL element emits light with brightness according to the current Iout.

As described above, according to this embodiment, by generating the correction current based on the correction data created for each pixel and adding the correction current to the gray-scale current, the adjustment of brightness can be conducted for each pixel. Accordingly, all pixels can emit light uniformly without any deviation.

### Second Embodiment

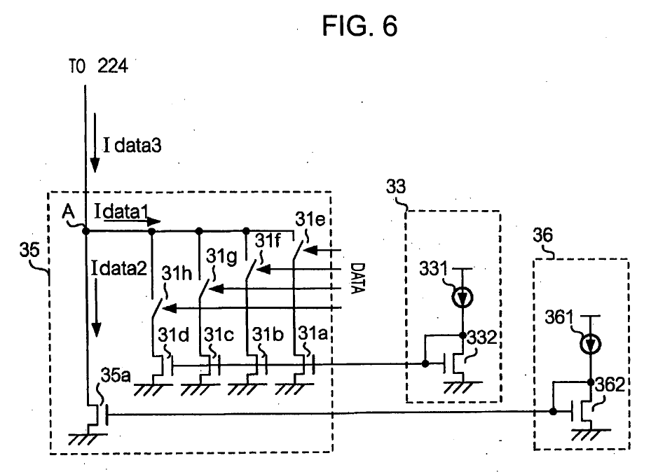

Next, a second embodiment of the present invention will be described. FIG. 6 is a diagram illustrating a DAC 35. In the second embodiment, the DAC 35 is used instead of the DACs 31 and 32 of the first embodiment. The same elements as in the first embodiment are denoted by the same reference numerals.

In FIG. 6, for the purpose of avoiding the complexity of the figure, only the DAC 35, the reference voltage generating circuit 33, and a reference voltage generating circuit 36, which correspond to the j-th column data line 12, are shown.

Next, the configuration of the DAC 35 will be described. The DAC 35 is a partially modified version of the DAC 31 of the first embodiment. Here, a difference between the DAC 35 and the DAC31 will be described. The DAC 35 has a transistor 35a in addition to the configuration of the DAC 31. A source of the transistor 35a is grounded and a drain of the transistor 35a is connected to the terminal A. The reference voltage generating circuit 36 has a current source 361 and a transistor 362. The current source 361 generates an adjustable current. The transistor 362 is an n-channel transistor and has a drain connected to the current source 361 and a source grounded. Here, the drain and a gate of the transistor 362 are shorted therebetween thereby forming a diode junction. In addition, a current mirror circuit is formed by connection between the gate of the transistor 362 and the gate of the transistor 35a. Accordingly, a gate voltage having the same magnitude as a gate voltage of the transistor 362 is applied to the gate of the transistor 35a, and accordingly, a current according to the gate voltage flows between the source and the drain of the transistor 35a.

Now, operation of the electro-optic device 100, as configured above, in the second embodiment will be described. The DAC 35 uses the reference voltage generated in the reference voltage generating circuit 33 and generates the gray-scale data Idata1 according to the gray-scale data. The reference voltage generating circuit 36 generates the correction current Idata2 by the adjustable current source 361. Also, the gray-scale current Idata1 and the correction current Idata2 are added each other at the terminal A to generate the current Idata3.

The current Idata3 is supplied to the current-voltage conversion circuit 224, which then generates the voltage Vout according to the supplied current Idata3 and outputs the voltage Vout to the buffer circuit 225. The buffer circuit 225 applies the voltage Vout to each data line 12. When the voltage Vout is applied to the data line 12, the current Iout according to the Vout is supplied to the organic EL element provided in the pixel circuit 16 according to the operation as described above, and accordingly, the organic EL element emits light with brightness according to the current Iout.

As described above, according to this embodiment, by generating the correction current for each pixel and adding the correction current to the gray-scale current, the adjustment of brightness can be conducted for each pixel. Accordingly, all pixels can emit light uniformly without any deviation.

### Third Embodiment

Next, a third embodiment of the present invention will be described. Hereinafter, The same elements as in the first embodiment are denoted by the same reference numerals, and explanation thereof is omitted.

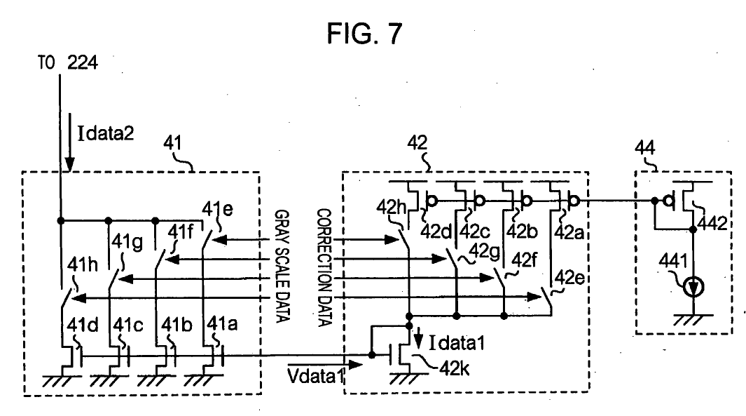

To begin with, the DAC 222 will be described. FIG. 7 is a diagram illustrating the configuration of the DAC 222 and the reference voltage generating circuit 223. The DAC 222 is composed of n DACs 41 and n DACs 42, which correspond to each data line 12. The DAC 41 is a DAC for generating a gray-scale current based on gray-scale data and the DAC 42 is a DAC for generating a correction voltage based on correction data and applying the correction voltage to the DAC 41.

The reference voltage generating circuit 223 is composed of n reference voltage generating circuits 44 corresponding to the DAC 42, respectively, and applies a reference voltage to the DAC 42.

In FIG. 7, for the purpose of avoiding the complexity of the figure, only the DAC 41, the DAC 42, and the reference voltage generating circuit 44, which correspond to the j-th column data line 12, are shown.

Next, the configuration of the DAC 42 and the reference voltage generating circuit 44 will be described. The DAC 42 includes a transistor 42a, a transistor 42b, a transistor 42c, and a transistor 42d. All of the transistors 42a to 42d are a p-channel transistor and have sources connected to an power supply voltage at an upper side. In addition, drains of the transistors 42a to 42d are connected to one ends of switches 42e, 42f, 42g, and 42h, respectively. A transistor 42k is an n-channel transistor, and all of the other ends of the switches 42e to 42h are connected to a drain of the transistor 42k. A source of the transistor 42k is grounded. The reference voltage generating circuit 44 includes a constant current source 441 and a transistor 442. The transistor 442 is a p-channel transistor and has a drain connected to the constant current source 441 and a source connected to the power supply voltage at the upper side. Here, the drain and a gate of the transistor 442 are shorted therebetween, thereby forming a diode junction. In addition, a current mirror circuit is formed by connection between the gate of the transistor 442 and gates of the transistors 42a to 42d. Accordingly, a gate voltage having the same magnitude as a gate voltage of the transistor 442 is applied to the gates of the transistors 42a to 42d, and accordingly, a current according to the gate voltage (element current) flows between the sources and the drains of the transistors 42a to 42d.

Here, a size ratio of channels of the transistors 42a to 42d will be described. The transistors 42a to 42d have the same channel length L1 and different channel widths. Assuming the channel widths of the transistors 42a, 42b, 42c and 42d are Wa, Wb, Wc, and Wd, respectively, a ratio between them, that is, Wa:Wb:Wc:Wd=1:2:4:8. A gain coefficient β of a transistor is expressed as μCW/L. Where, μ is mobility of carriers, C is a gate capacitance, W is a channel width, and L is a channel length. Accordingly, a current flowing through the transistor is in proportion to the channel width. Accordingly, when the same gate voltage is applied to the transistors 42a to 42d, a ratio of currents flowing through the transistors 42a, 42b, 42c and 42d is 1:2:4:8.

Here, the correction data will be described. Input/output characteristics of the organic EL element are changed depending on environmental conditions such as temperature and external light, and change of the organic EL element itself with time. In addition, deviations of the input/output characteristics occur due to deviations of characteristics of the driving transistors provided in the pixel circuits 16. Accordingly, in consideration of the variation of environmental conditions or the change of the organic EL element itself with time, there rises a need to correct peak brightness of the organic EL element or gradient data of gamma correction for each pixel. Data used to conduct such a correction is the correction data in this embodiment.

In addition, the correction data may be stored in the image memory together the gray-scale data.

In this embodiment, the correction data is composed of binary numbers of 4 bits. When the correction data is supplied to the DAC 42 via the line memory 221, the switches 42e to 42h are switched on/off according to the correction data. In more detail, each bit of the correction data corresponds to the switches 42e, 42f, 42g, and 42h, starting from the least significant bit. For example, if the least significant bit is 0, the switch 42e is switched off, and if the least significant bit is 1, the switch 42e is switched on. In this way, the switches 42e to 42h are switched on/off based on the correction data, and currents flow through transistors corresponding to switches switched on. Accordingly, a total current obtained by adding individual currents flowing through the respective transistors can has current values of 16 steps including zero, and a correction current Idata1 having a magnitude according to the correction data is outputted. In addition, the correction current Idata1 is supplied to the drain of the transistor 42k, and accordingly, a correction voltage Vdata1 having a magnitude according to the correction current Idata1 is generated between the gate and the source of the transistor 42k.

Next, the configuration of the DAC 41 will be described. The DAC 41 includes a transistor 41a, a transistor 41b, a transistor 41c, and a transistor 41d. All of the transistors 41a to 41d are an n-channel transistor and have sources grounded. In addition, drains of the transistors 41a to 41d are connected to one ends of switches 41e, 41f, 41g, and 41h, respectively. Here, a current mirror circuit is formed by connection between the gate of the transistor 42k of the DAC 42 and gates of the transistors 41a to 41d. Accordingly, a gate voltage having the same magnitude as a gate voltage of the transistor 42k is applied to the gates of the transistors 41a to 41d, and accordingly, a current according to the gate voltage flows between the sources and the drains of the transistors 41a to 41d.

For a size ratio of channels of the transistors 41a to 41d, the transistors 41a to 41d have the same channel length L1 and different channel widths, like the transistors 42a to 42d. Assuming the channel widths of the transistors 41a, 41b, 41c and 41d are Wa, Wb, Wc, and Wd, respectively, a ratio between them, that is, Wa:Wb:Wc:Wd=1:2:4:8. Accordingly, when the same gate voltage is applied to the transistors 41a to 41d, a ratio of currents flowing through the transistors 41a, 41b, 41c and 41d is 1:2:4:8. The gray-scale data is composed of binary numbers of 4 bits and has data values of 16 steps including zero.

Now, operation of the electro-optic device 100 as configured above will be described. The DAC 42 corrects the reference voltage generated in the reference voltage generating circuit 44 using the correction data and outputs the correction voltage Vdata1 (the gate voltage of the transistor 42k). The DAC 42 generates the gray-scale current Idata2 according to the gray-scale data. A voltage used to generate the gray-scale current Idata2 is the correction voltage Vdata1 outputted from the transistor 42k of the DAC 42. That is, by correcting a reference current when the gray-scale current Idata2 is generated, a dynamic range of the gray-scale current can be adjusted. Also, the DAC 41 supplies the generated gray-scale current Idata2 to the current-voltage conversion circuit 224.

The current-voltage conversion circuit 224 generates a voltage Vout according to the supplied current Idata2 and outputs the voltage Vout to the buffer circuit 225. The buffer circuit 225 applies the voltage Vout to each data line 12. When the voltage Vout is applied to the data line 12, a current Iout according to the voltage Vout is supplied to the organic EL element provided in the pixel circuit 16 according to the operation as described above, and accordingly, the organic EL element emits light with brightness according to the current Iout.

In addition, although this embodiment is configured such that the reference voltage generated in the reference voltage generating means is corrected by the correction means and the gray-scale current generating means generates the gray-scale current using the corrected reference voltage. It may be configured such that the gray-scale current generating means generates the gray-scale current using the reference current and the gray-scale current is corrected by the correction means.

As described above, according to this embodiment, by generating the correction voltage based on the correction data created for each pixel and generating the gray-scale current according to the gray-scale data using the correction voltage, a dynamic range of brightness can be adjusted for each pixel. Accordingly, all pixels can emit light uniformly without any deviation.

### Fourth Embodiment

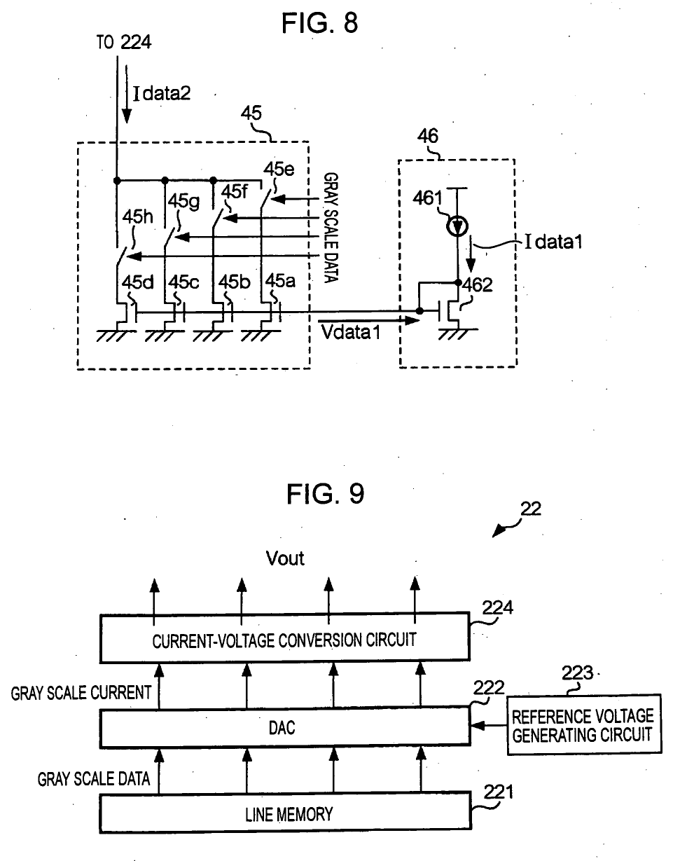

Next, a fourth embodiment of the present invention will be described. FIG. 8 is a diagram illustrating a DAC 45. In the fourth embodiment, the DAC 45 is used instead of the DACs 41 and 42 of the third embodiment. The same elements as in the third embodiment are denoted by the same reference numerals.

In FIG. 8, for the purpose of avoiding the complexity of the figure, only the DAC 45 and a reference voltage generating circuit 46, which correspond to the j-th column data line 12, are shown.

Next, the configuration of the DAC 45 will be described. The DAC 45 has the same configuration as that of the DAC 41 of the first embodiment. The reference voltage generating circuit 46 has a constant current source 461 and a transistor 462. The transistor 462 is an n-channel transistor and has a drain connected to the current source 461 and a source grounded. Here, the drain and a gate of the transistor 462 are shorted therebetween, thereby forming a diode junction. In addition, a current mirror circuit is formed by connection between the gate of the transistor 462 and gates of transistors 45a to 45d. Accordingly, a gate voltage having the same magnitude as a gate voltage of the transistor 462 is applied to the gates of the transistors 45a to 45d, and accordingly, a current according to the gate voltage flows between the sources and the drains of the transistors 45a to 45d.

Now, operation of the electro-optic device 100, as configured above, in the fourth embodiment will be described. The reference voltage generating circuit 46 outputs the correction voltage Vdata1 by the adjustable current source 461. The DAC 45 generates the gray-scale current Idata2 according to the gray-scale data. A voltage used to generate the gray-scale current Idata2 is the correction voltage Vdata1 outputted from the transistor 462 of the reference voltage generating circuit 46. That is, by correcting a reference current when the gray-scale current Idata2 is generated, a dynamic range of the gray-scale current can be adjusted. Also, the DAC 45 supplies the generated gray-scale current Idata2 to the current-voltage conversion circuit 224.

The current-voltage conversion circuit 224 generates a voltage Vout according to the supplied current Idata2 and outputs the voltage Vout to the buffer circuit 225. The buffer circuit 225 applies the voltage Vout to each data line 12. When the voltage Vout is applied to the data line 12, a current Iout according to the voltage Vout is supplied to the organic EL element provided in the pixel circuit 16 according to the operation as described above, and accordingly, the organic EL element emits light with brightness according to the current Iout.

As described above, according to this embodiment, by generating the correction voltage for each pixel and generating the gray-scale current according to the gray-scale data using the correction voltage, a dynamic range of brightness can be adjusted for each pixel. Accordingly, all pixels can emit light uniformly without any deviation.

### Fifth Embodiment

Next, a fifth embodiment of the present invention will be described. Hereinafter, the same elements as in the first embodiment are denoted by the same reference numerals, and explanation thereof is omitted.

To begin with, a data line driving circuit 22 will be described. FIG. 9 is a diagram illustrating the configuration of the data line driving circuit 22. A line memory 221 stores gray-scale data corresponding to pixels provided at intersections of the scanning line 11 selected by the scanning line driving circuit 21 and each data line 12. The gray-scale data is supplied from the image memory 80. A reference voltage generating circuit 223 generates a reference voltage and applies it to a DAC 222. The DAC 222 generates a current according to the gray-scale data of respective pixel circuits 16, which is supplied from the line memory 221, and supplies the generated current to a current-voltage conversion circuit 224. The current-voltage conversion circuit 224 generates a voltage (data signal) according to the supplied current and outputs it to each data line 12.

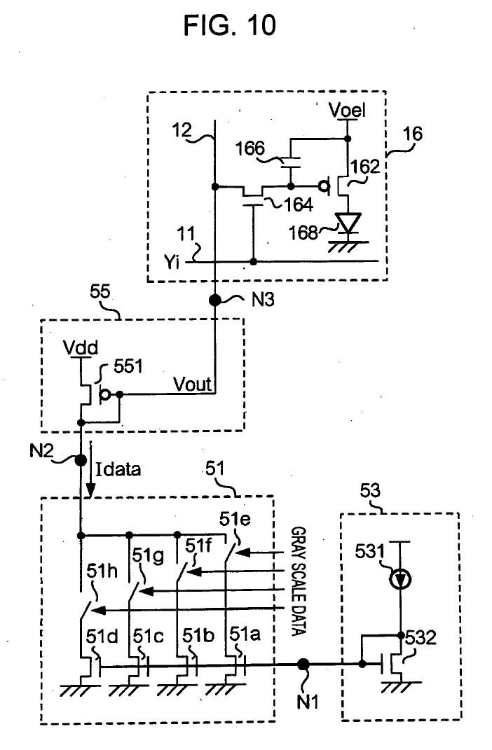

Next, the configurations of the DAC 222, the reference voltage generating circuit 223, and the current-voltage conversion circuit 224 will be described. FIG. 10 is a diagram illustrating the configuration of the DAC 222, the reference voltage generating circuit 223, and the current-voltage conversion circuit 224. The DAC 222 is composed of n DACs 51 which correspond to each data line 12. The DAC 51 is a DAC for generating a gray-scale current based on the gray-scale data.

The reference voltage generating circuit 223 is composed of n reference voltage generating circuits 53 corresponding to the DAC 51, respectively, and applies the reference voltage to the DAC 51.

The current-voltage conversion circuit 224 is composed of n current-voltage conversion circuits 55 corresponding to the DAC 51, respectively, and generates a voltage according to the gray-scale current supplied from the DAC 51, and outputs the generated voltage to each line 12.

In FIG. 10, for the purpose of avoiding the complexity of the figure, only the DAC 51, the reference voltage generating circuit 53, and the current-voltage conversion circuit 55, which correspond to the j-th column data line 12, are shown. In addition, a pixel circuit 16 provided at an intersection between an i-th row scanning line 11 and a j-th column data line 12 is shown in FIG. 10.

Next, the configuration of the DAC 51, the reference voltage generating circuit 53, and the current-voltage conversion circuit 55 will be described.

The DAC 51 includes a transistor 51a, a transistor 51b, a transistor 51c, and a transistor 51d. All of the transistors 51a to 51d are an n-channel transistor and have sources grounded. In addition, drains of the transistors 51a to 51d are connected to one ends of switches 51e, 51f, 51g, and 51h, respectively. All of the other ends of the switches 51e to 51h are connected in common to a drain of a transistor 551 provided in the current to voltage circuit 55.

The reference voltage generating circuit 53 includes a current source 531 and a transistor 532. The current source 531 adjusts the amount of current to be outputted. The transistor 532 is an n-channel transistor and has a drain connected to the current source 531 and a source grounded. Here, the drain and a gate of the transistor 532 are shorted therebetween, thereby forming a diode junction. In addition, a current mirror circuit is formed by connection between the gate of the transistor 532 and gates of the transistors 51a to 51d. Accordingly, a gate voltage having the same magnitude as a gate voltage of the transistor 532 is applied to the gates of the transistors 51a to 51d, and accordingly, a current according to the gate voltage flows between the sources and the drains of the transistors 51a to 51d. In addition, instead of the reference voltage generating circuit 53, a voltage by an external input or a voltage obtainable through resistors and the like can be used.

A source of the p-channel transistor 551 provided in the current-voltage conversion circuit 55 is connected to an power supply voltage Vdd at an upper side, and the drain and a gate of the transistor 551 are shorted therebetween, thereby forming a diode junction. In addition, the gate of the transistor 551 is connected to the data line 12. That is, during a period when the i-the row scanning line 11 is selected, current mirror connection is formed by the transistor 551 and a transistor 162.

Here, a size ratio of channels of the transistors 51a to 51d will be described. The transistors 51a to 51d have the same channel length L1 and different channel widths. Assuming the channel widths of the transistors 51a, 51b, 51c and 51d are Wa, Wb, Wc, and Wd, respectively, a ratio between them, that is, Wa:Wb:Wc:Wd=1:2:4:8. A gain coefficient β of a transistor is expressed as μCW/L. Where, μ is mobility of carriers, C is a gate capacitance, W is a channel width, and L is a channel length. Accordingly, a current flowing through the transistor is in proportion to the channel width. Accordingly, when the same gate voltage is applied to the transistors 51a to 51d, a ratio of currents flowing through the transistors 51a, 51b, 51c and 51d is 1:2:4:8.

In this embodiment, the gray-scale data is composed of binary numbers of 4 bits. When the gray-scale data is supplied to the DAC 51 via the line memory 221, the switches 51e to 51h are switched on/off according to the gray-scale data. In more detail, each bit of the gray-scale data corresponds to the switches 51e, 51f, 51g, and 51h, starting from the least significant bit. For example, if the least significant bit is 0, the switch 51e is switched off, and if the least significant bit is 1, the switch 51e is switched on. In this way, the switches 51e to 51h are switched on/off based on the gray-scale data, and currents flow through transistors corresponding to switches switched on. Accordingly, a total current obtained by adding individual currents flowing through the respective transistors can has current values of 16 steps including zero, and a gray-scale current Idata having a magnitude according to the gray-scale data is outputted.

In general, transistors provided in a pixel circuit are different in manufacture process from transistors provided in a data line driving circuit. In most cases, thin film transistors (TFT) are used in the pixel circuit, and an integrated circuit (IC) composed of metal oxide semiconductor field effect transistors (MOSFET) is used in the data line driving circuit. Transistors having different manufacture processes have different gain coefficients β and different threshold voltages Vth in Equation 1. In this embodiment, even when the transistors has the different gain coefficients β and the different threshold voltages Vth, desired currents can be supplied to an organic EL element 168. Hereinafter, this configuration will be described.

To begin with, an adjustment in consideration of the difference between the gain coefficients β will be described. As can be seen from Equation 1, a current supplied by a transistor is in proportion to the gain coefficients β. If the gain coefficients β of the transistor 162 in the pixel circuit 16 is double the gain coefficients β of the transistor 551 in the current-voltage conversion circuit 55, the transistor 162 outputs a current Iout having a double magnitude of the gray-scale current Idata supplied from the DAC 51 to the transistor 551. Considering this, the gray-scale current is adjusted to satisfy the following relationship in this embodiment:

(β of the transistor 551):(β of the transistor 162)=Idata:Iout (2)

The gray-scale current can be adjusted by adjusting a current supplied from the current source 531 in the reference voltage generating circuit 53. Accordingly, an output current Iout having desired magnitude is outputted from the transistor 162.

Next, an adjustment in consideration of the difference between the threshold voltages will be described. As can be seen from Equation 1, a current supplied by a transistor depends on a difference between a gate voltage Vgs and a threshold voltage Vth. If a threshold voltage of the transistor 551 in the current-voltage conversion circuit 55 is lower by V1 than a threshold voltage of the transistor 162 in the pixel circuit 16, a current supplied to the organic EL element becomes decreased by the amount corresponding to V1 for a desired current. On the contrary, if the threshold voltage of the transistor 551 is higher by V1 than the threshold voltage of the transistor 162, a current supplied to the organic EL element becomes increased by the amount corresponding to V1 for the desired current. As a result, the organic EL element cannot emit light with desired brightness. In order to overcome this problem, in this embodiment, a voltage for compensating a threshold voltage difference between the driving transistor 162 in the pixel circuit 16 and the transistor 551 in the current-voltage conversion circuit 55 is outputted to the pixel circuit 16. That is, if the threshold voltage of the transistor 551 is lower by V1 than the threshold voltage of the transistor 162, an power supply voltage Vdd at an upper side of the transistor 551 is set to a voltage lower by V1 than an power supply voltage Voe1 at an upper side of the transistor 162. On the contrary, if the threshold voltage of the transistor 551 is higher by V1 than the threshold voltage of the transistor 162, the power supply voltage Vdd is set to a voltage higher by V1 than the power supply voltage Voe1. Accordingly, even when there is a threshold voltage difference between a driving transistor in the pixel circuit and a transistor in the current-voltage conversion circuit, a desired gray-scale current Iout is outputted.

Now, operation of the electro-optic device 100, as configured above, in the fifth embodiment will be described.

To begin with, when the i-th row scanning line 11 is selected, and accordingly, the scan signal Yi goes into an H level, the transistor 164 is turned on. The DAC 51 generates the gray-scale current Idata according to the gray-scale data corresponding to pixels provided at the intersection between the i-the scanning line 11 and the j-th column data line 12 using the reference voltage generated in the reference voltage generating circuit 53.

The gray-scale current Idata is supplied to the current-voltage conversion circuit 55, which then generates the voltage Vout according to the supplied gray-scale current Idata and outputs the voltage Vout to each data line 12. When the voltage Vout is outputted to the data line 12, the current Iout according to the voltage Vout is supplied to the organic EL element 168 according to the operation of the pixel circuit 16 as described above, and accordingly, the organic EL element 168 emits light with brightness according to the current Iout.

As described above, according to this embodiment, even when characteristics of the driving transistor of the pixel circuit are different from those of the transistor of the driving circuit, the pixels can emit light with desired brightness.

In addition, although an attention has been paid to the difference of the gain coefficients β and that of the threshold voltages Vth due to the difference in manufacture process between the transistor in the pixel circuit and the transistor in the current-voltage conversion circuit in the above description, transistors of the same kind may have different gain coefficients β and different threshold voltages Vth. The transistor used in the pixel circuit 16 is typically a TFT, as described earlier, where deviations of the gain coefficients β and the threshold voltages Vth are apt to occur. As a result, brightness deviation may occur for each pixel. The adjustment method of brightness according to the present invention is effective even when the brightness deviation occurs for each pixel. Using the adjustment method of the present invention, since the deviation of brightness can be adjusted for each pixel, the pixels can emit light with desired brightness.

### Sixth Embodiment

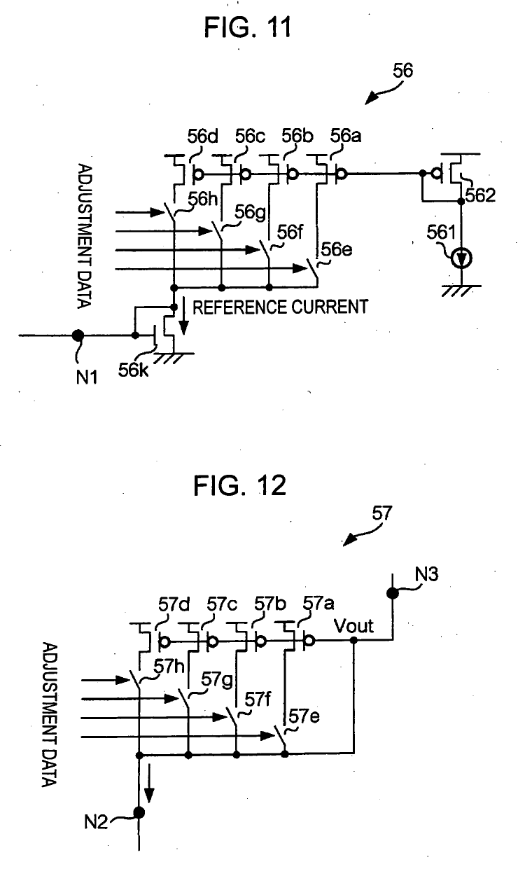

Next, a sixth embodiment of the present invention will be described. FIG. 11 is a diagram illustrating a reference voltage generating circuit 56. In the sixth embodiment, the reference voltage generating circuit 56 is used instead of the reference voltage generating circuit 53 of the fifth embodiment. The same elements as in the fifth embodiment are denoted by the same reference numerals. N reference voltage generating circuits 56 are provided corresponding to the data lines 12.

In FIG. 11, for the purpose of avoiding the complexity of the figure, only the reference voltage generating circuit 56, which corresponds to the j-th column data line 12, is shown.

Next, the configuration of the reference voltage generating circuit 56 will be described. The reference voltage generating circuit 56 includes a transistor 56a, a transistor 56b, a transistor 56c, and a transistor 56d. All of the transistors 56a to 56d are a p-channel transistor and have sources connected to an power supply voltage at an upper side. In addition, drains of the transistors 56a to 56d are connected to one ends of switches 56e, 56f, 56g, and 56h, respectively. A transistor 56k is an n-channel transistor, and all of the other ends of the switches 56e to 56h are connected to a drain of the transistor 56k. A source of the transistor 56k is grounded. In addition, the reference voltage generating circuit 56 includes a current source 561 and a transistor 562. The transistor 562 is a p-channel transistor and has a drain connected to the current source 561 and a source connected to the power supply voltage at the upper side. Here, the drain and a gate of the transistor 562 are shorted therebetween, thereby forming a diode junction. In addition, a current mirror circuit is formed by connection between the gate of the transistor 562 and gates of the transistors 56a to 56d. Accordingly, a gate voltage having the same magnitude as a gate voltage of the transistor 562 is applied to the gates of the transistors 56a to 56d, and accordingly, a current according to the gate voltage flows between the sources and the drains of the transistors 56a to 56d.

A size ratio of channels of the transistors 56a to 56d is equal to that of the transistors 51a to 51d in the fifth embodiment. Accordingly, a ratio of currents flowing through the transistors 56a, 56b, 56c and 56d is 1:2:4:8. When adjustment data composed of binary numbers of 4 bits is inputted, the switches 56e to 56h are switched on/off based on the adjustment data, and currents flow through transistors corresponding to switches switched on. Accordingly, a total current obtained by adding individual currents flowing through the respective transistors can has current values of 16 steps including zero. Accordingly, a reference current having a magnitude according to the adjustment data can be outputted. In addition, the reference current is supplied to the drain of the transistor 56k, and accordingly, a reference voltage according to the magnitude of the reference current is generated between the gate and the source of the transistor 56k.

As described above, according to this embodiment, even when the characteristics of the driving transistor of the pixel circuit are different from those of the transistor of the driving circuit, the pixels can emit light with desired brightness.

### Seventh Embodiment

Next, a seventh embodiment of the present invention will be described. FIG. 12 is a diagram illustrating a current-voltage conversion circuit 57. In the seventh embodiment, the current-voltage conversion circuit 57 is used instead of the current-voltage conversion circuit 55 of the fifth embodiment. The same elements as in the fifth embodiment are denoted by the same reference numerals. n current-voltage conversion circuits 57 are provided corresponding to the data lines 12.

In FIG. 12, for the purpose of avoiding the complexity of the figure, only the current-voltage conversion circuit 57, which corresponds to the j-th column data line 12, is shown.

Next, the configuration of the current-voltage conversion circuit 57 will be described. The current-voltage conversion circuit 57 includes a transistor 57a, a transistor 57b, a transistor 57c, and a transistor 57d. All of the transistors 57a to 57d are a p-channel transistor and have sources connected to an power supply voltage at an upper side. In addition, drains of the transistors 57a to 57d are connected to one ends of switches 57e, 57f, 57g, and 57h, respectively. In addition, gates of the transistors 57a to 57d are connected in common. Accordingly, when the switches 57e to 57h are switched on, a diode junction is formed by shorting between the drains and the gates of the transistor 57a to 57d, respectively. In addition, the gates of the transistors 57a to 57d are connected to the data line 12. That is, during a period when the i-the row scanning line 11 is selected, current mirror connection is formed by the transistors 57a to 57d and a transistor 162.

A size ratio of channels of the transistors 57a to 57d is equal to that of the transistors 51a to 51d in the fifth embodiment. That is, the transistors 57a to 57d have the same channel length L1 and different channel widths. Assuming the channel widths of the transistors 57a, 57b, 57c and 57d are Wa, Wb, Wc, and Wd, respectively, a ratio between them, that is, Wa:Wb:Wc:Wd=1:2:4:8. When adjustment data composed of binary numbers of 4 bits is inputted, the switches 57e to 57h are switched on/off based on the adjustment data, and currents flow through transistors corresponding to switches switched on. At this time, assuming that a sum of channel widths of the transistors corresponding to the switches switched on is Ws, the transistors 57a to 57d are equivalent to one transistor having the channel width of Ws. In other words, the current-voltage conversion circuit 57 in this embodiment corresponds to adjustability of the channel width of the transistor 55 in the fifth embodiment. In consideration that the gain coefficients β of a transistor is in proportion to the channel width, the adjustment of the channel width is equivalent to the adjustment of the gain coefficients β.

As described above, according to this embodiment, even when the characteristics of the driving transistor of the pixel circuit are different from those of the transistor of the driving circuit, the pixels can emit light with desired brightness.

### Eighth Embodiment

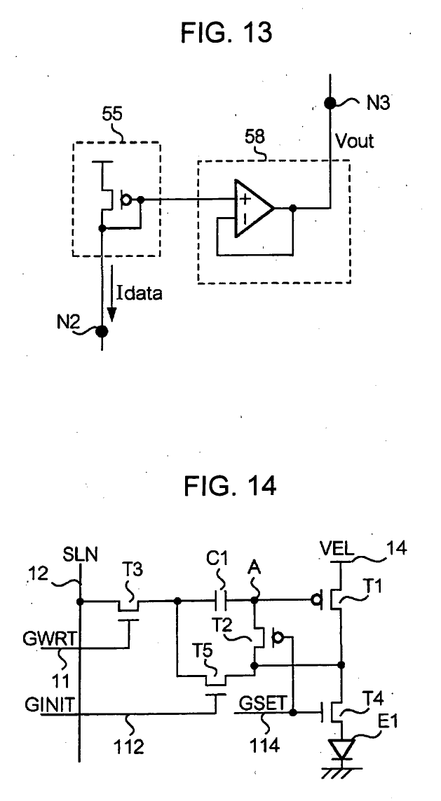

Next, an eighth embodiment of the present invention will be described. FIG. 13 is a diagram illustrating a configuration including a buffer circuit 58. The eighth embodiment is configured such that a voltage outputted from the current-voltage conversion circuit 55 in the fifth embodiment is outputted to the data line 12 via the buffer circuit 58. The buffer circuit 58 is a voltage follower, for example. The same elements as in the fifth embodiment are denoted by the same reference numerals. n buffer circuits 58 are provided corresponding to the data lines 12.

In FIG. 13, for the purpose of avoiding the complexity of the figure, only the buffer circuit 58, which corresponds to the j-th column data line 12, is shown.

Since the data line 12 has a parasite capacitance, it is necessary to charge (to write data) this parasite capacitance before storing charges in a capacitor 166 of the pixel circuit 16. Time required to write data in the data line depends on a current value and is prolonged when the gray-scale is low.

In this embodiment, a voltage is outputted to the data line 12 via the buffer circuit 58. With this configuration, since time required to write data in the data line 12 depends on current capability at an output terminal of the buffer circuit 58, time required to write data can be shortened even when the gray-scale is low.

### Ninth Embodiment

Next, a ninth embodiment of the present invention will be described. FIG. 14 is a diagram illustrating the configuration of a pixel circuit 17. The ninth embodiment uses the pixel circuit 17 of threshold voltage compensation type instead of the pixel circuit 16 in the fifth or sixth embodiment. In FIG. 14, although only the pixel circuit 17 provided at an intersection between the i-th row scanning line 11 and the j-th column data line 12 is shown, other pixel pixels 17 have the same configuration.

Transistors T1 and T2 are a p-channel transistor, and transistors T3, T4, and T5 is an n-channel transistors. The transistor T4 acts as a driving transistor for driving an organic EL element E1, and the transistors T1, T2, T3 and T5 act as a switching transistor. The transistor T3 has a gate connected to the scanning line 11, a source connected to the data line 12, and a drain connected to a source of the transistor T5 and one end of a capacitor C1. The other end of the capacitor C1 is connected to a gate of the transistor T1 and a drain of the transistor T2. The transistor T5 has a gate connected to an initialization control line 112 and a drain connected to the drain of the transistor T2, a drain of the transistor T1, and a drain of the transistor T4. The transistor T2 has a gate connected to a lightening control line 114 and the drain of the transistor T4. The transistor T4 has a source connected to an anode of the organic EL element E1 whose cathode is grounded. The transistor T1 has a source connected to a power line 14 to which a power supply voltage VEL is applied at an upper side.

The scanning line driving circuit 21 supplies a scan signal GWRT to the scanning line 11, a control signal GINIT to the initialization control signal 112, and a control signal GSET to the lightening control line 114.

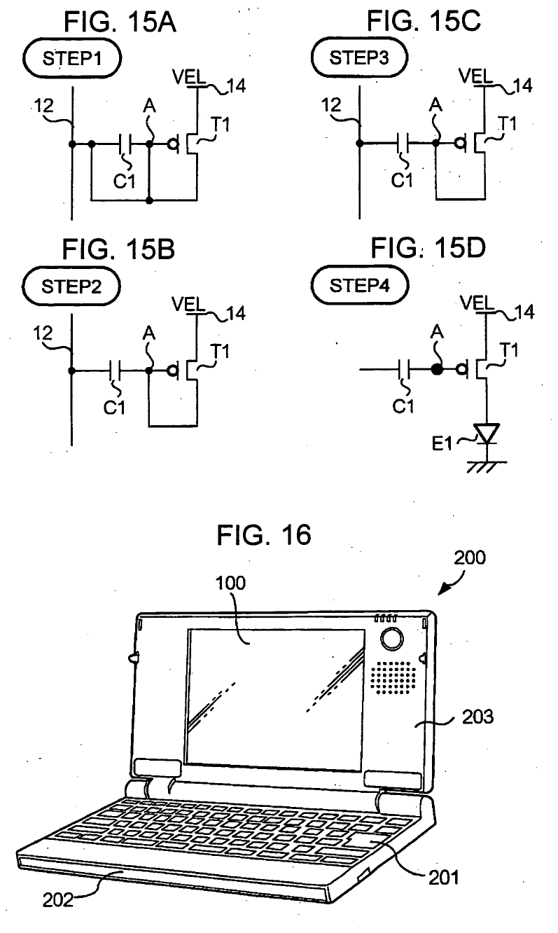

Next, operation of the pixel circuit 17 provided at the intersection between the i-th row scanning line 11 and the j-th column data line 12 will be described. FIG. 15 is a diagram illustrating the operation of the pixel circuit 17. The operation of the pixel circuit 17 can be divided into 4 periods. STEP1 to STEP4 in FIG. 15 correspond to periods (1) to (4), respectively.

To begin with, in period (1), the scanning line driving circuit 21 makes the control signal GSET an L level and the control signal GINIT an H level. In addition, the data line driving circuit 22 sets data signals supplied to all data lines 12 at an initialization voltage VS. Here, VS is a voltage lower by a certain value than VEL.

As shown in FIG. 15A, during period (1), the driving transistor T1 acts as a diode since the transistor T2 is turned on, while a current path to the organic EL element E1 is intercepted since the transistor T4 is turned off. Also, transistor T5 is turned on as the control signal GINIT goes into the H level, and the transistor T3 is turned on as the scan signal GWRT goes into the H level. Accordingly, the gate of the driving transistor T1 has approximately the same initialization voltage VS as the data line 12.

Next, during period (2), the scanning line driving circuit 21 maintains the control signal GSET at the L level and returns the control signal GINIT to the L level. In addition, the data line driving circuit 22 maintains the data signals at the initialization voltage VS.

As shown in FIG. 15B, during period (2), while the driving transistor T1 continues to act as a diode as the transistor T2 continues to be turned on, the current path from the power line 14 to the data line 12 is intercepted since the transistor T5 is turned off as the control signal GINIT goes into the L level.

On the other hand, as the transistor T2 continues to be turned on, a voltage at one end of the capacitor C1, i.e., at a node A, is going to change to (VEL−Vth), which is the subtraction of a threshold voltage Vth of the driving transistor T1 from the power supply voltage VEL at the upper side. But, as the transistor T3 is turned on, since the other end of the capacitor C1 is maintained at the initialization voltage VS at the data line 12, a voltage at the node A is varied according to charging/discharging in the capacitor C1 (and a gate capacitance of the driving transistor T1). However, since charges of the capacitor C1 are cleared by a short during period (1) and the voltage variation at the node A is small after period (1), it does not take a long time for the voltage at the node A to reach (VEL−Vth) during period (2). On this account, the voltage at the node A at the timing of end of period (2) may be considered to be (VS−(VEL−Vth)).

Next, during period (3), the data line driving circuit 22 converts a voltage of a data signal X from an initialization voltage (VEL−Vth) to a voltage (VEL−Vth−ΔV). Here, ΔV is determined by video data according to a pixel in an i-th row and a j-th column and is a value approaching to zero as an organic EL element E1 of a corresponding pixel becomes darker. Accordingly, the voltage (VEL−Vth−ΔV) means a gray-scale voltage according to the amount of current flowing into the organic EL element E1.

As shown in FIG. 15C, during period (3), since transistor T2 is turned off, the one end (the node A) of the capacitor C1 is merely maintained by only the gate capacitance of the driving transistor T1. On this account, the voltage at the node A is reduced by an extent of the voltage variation ΔV at the other end of the capacitor C1, which is distributed by a capacitance ratio of the capacitor Cl to the gate capacitance of the driving transistor T1 from the voltage (VEL−Vth). More specifically, assuming that capacitance of the capacitor C1 is Cprg and the gate capacitance of the driving transistor T1 is Ctp, the node A is reduced by {ΔV·Cprg/(Ctp+Cprg)} from the off voltage (VEL−Vth). Accordingly, a voltage of {VEL−Vth−ΔV·Cprg/(Ctp+Cprg)} is generated at the node A.

In addition, a current according to the voltage at the node A flows through the organic EL element E1, thus emitting light. At this time, the voltage at the node A is a target voltage according to a current which must flow through the organic EL element E1.

Next, during period (4), the scanning line driving circuit 21 makes the scan signal GWRT the L level and the control signal GSET the H level.

As shown in FIG. 15D, during period (4), although the transistor T3 is turned off, the node A is maintained at the target voltage of {VEL−Vth−ΔV·Cprg/(Ctp+Cprg)} by the gate capacitance of the driving transistor T1 (and the capacitor C1). Accordingly, during period (4), since a current according to the target voltage continues to flow through the organic EL element E1, the organic EL element E1 continues to emit light with brightness specified by video data.

After period (4) is ended, when the control signal GSET goes into the L level, since the transistor T4 is turned off, and accordingly, the current path to the organic EL element E1, the organic EL element E1 lights off.

According to this embodiment, since a target voltage according to a current which must flow through the organic EL element is written in the gate of the driving transistor, deviation of a threshold voltage of the driving transistor can be compensated. Accordingly, since deviation of brightness due to the deviation of the threshold voltage of the driving transistor can be adjusted, the pixels can emit light with desired brightness.

<Modifications>

The present invention can be carried out in various ways with no limitation to the above embodiments. For example, the above embodiments can be modified as follows.

For the first and second embodiments, the reference voltage outputted from the reference voltage generating circuit 33 may be a voltage by an external input or a voltage obtainable through resistors and the like. In addition, by making the voltage adjustable, a dynamic range of the gray-scale current outputted from the DAC 31 or the DAC 35 can be adjusted. As a result, a dynamic range of brightness can be adjusted for each pixel.

In addition, the correction current may be a current by an external input or a current obtainable through resistors and the like.

In addition, the DAC 32 for generating the correction current may be shared by a plurality of data lines 12.

For the third embodiment, the reference voltage inputted to the DACs 31 and 32 may be a voltage by an external input or a voltage obtainable through resistors and the like. In addition, by making the voltage adjustable, a dynamic range of the gray-scale current outputted from the DAC 31 or the DAC 35 can be adjusted. As a result, a dynamic range of brightness can be adjusted for each pixel.

In addition, the correction current may be a current by an external input or a current obtainable through resistors and the like.

In addition, the DAC 32 for generating the correction current may be shared by a plurality of data lines 12.

Although cases where the present invention is applied to the organic EL display have been described in the above embodiments, the present invention may be applied to electro-optic devices other than the organic EL display. That is, the present invention may be applied to devices for displaying images using electro-optic materials for converting an electric operation such as current supply or voltage application to an optical operation such as variation of brightness or transmittance.

For example, the present invention may be applied to various electro-optic devices including an active matrix type electro-optic panel using thin film diodes (TFD) as active elements, a passive matrix type electro-optic device with liquid crystal interposed between substrates by intersection between stripped electrodes, an electrophoresis display using micro capsules containing colored liquid and white particles dispersed in the colored liquid as an electro-optic material, a twist ball display using twist balls with different regions colored by different colors as an electro-optic material, a toner display using black toner as an electro-optic material, or a plasma display panel (PDP) using high-pressurized gases such as helium or neon as an electro-optic material.

Next, examples of electro apparatuses using the electro-optic device according to the present invention will be described.

FIG. 16 is a diagram showing a personal computer 200 using the electro-optic device 100. In the figure, the personal computer 200 includes a body 202 having a keyboard 201, and a display unit 203 using the electro-optic device according to the present invention.

In addition to the personal computer, electronic apparatuses to which the electro-optic device according to the present invention is applicable include a potable telephone, a liquid crystal TV, a view finder type or monitor direct view type video tape recorder, a car navigation apparatus, a pager, an electronic pocket notebook, a calculator, a word processor, a workstation, a video telephone, a POS terminal, a digital still camera, etc.

What is claimed is:

1. A data line driving circuit for applying a current or a voltage via data lines to pixels formed corresponding to intersections of a plurality of scanning lines and the plurality of data lines in an electro-optic device including a scanning line driving circuit for sequentially selecting the plurality of scanning lines and supplying selection signals to the selected scanning lines, the data line driving circuit comprising:
a gray-scale current generating means for generating a gray-scale current according to gray-scale data representing gray-scale of pixels connected to corresponding scanning lines during a period when the selection signals are supplied to the scanning lines;
a correction current generating means for generating a correction current for correcting the brightness of the pixels;
a current-voltage converting means for generating a voltage according to a current obtained by adding the gray-scale current generated by the gray-scale current generating means to the correction current generated by the correction current generating means;
a means for applying the voltage generated by the current-voltage converting means to the data lines, generating a current according to the voltage and applying the current to pixels via the data lines;
a current source for adjusting an amount of a current in each gray-scale range; and
a reference voltage generating means for generating a reference voltage using the current supplied from the current source,
the gray-scale current generating means generating the gray-scale current using the reference voltage generated by the reference voltage generating means, and
the correction current generating means generating the correction current using the reference voltage generated by the reference voltage generating means.

2. The data line driving circuit according to claim 1, wherein the amount of current generated by the current source is adjustable.

3. A data line driving circuit for driving a plurality of data lines in an electro-optic device including pixels formed at intersections of a plurality of scanning lines and the plurality of data lines, and a scanning line driving circuit for sequentially selecting the plurality of scanning lines and supplying selection signals to the selected scanning lines, the data line driving circuit comprising:
a reference voltage generating means for generating a reference voltage to be used for generating a gray-scale current;
a correction means for correcting the reference voltage generated by the reference voltage generating means;
a gray-scale current generating means for generating a gray-scale current using the reference voltage corrected by the correction means;
a current-voltage converting means for generating a voltage according to the gray-scale current generated by the gray-scale current generating means; and
a means for applying the voltage generated by the current-voltage converting means to the data lines.

4. The data line driving circuit according to claim 3,
wherein the correction means corrects the reference voltage based on correction data for correcting the brightness of each pixel.

5. The data line driving circuit according to claim 3,
wherein the gray-scale current generating means is a digital-analog conversion circuit of the current addition type for generating a plurality of element currents using the reference voltage corrected by the correction means and for generating the gray-scale current by adding element currents selected from the plurality of element currents based on gray-scale data.

6. The data line driving circuit according to claim 4,
wherein the correction means is a digital-analog conversion circuit of the current addition type for generating a plurality of element currents using the reference voltage generated by the reference voltage generating means, and generating a voltage according to a current obtained by adding element currents to each other, which are selected from the plurality of element currents based on the correction data.

7. The data line driving circuit according to claim 4, further comprising storing means for storing the correction data,
wherein the correction means reads the correction data stored in the storing means and corrects the reference voltage based on the correction data.

8. The data line driving circuit according to claim 3,
wherein a plurality of correction means are provided to correspond to the same number of data lines.

9. The data line driving circuit according to claim 3,
wherein the reference voltage generating means includes a current source for adjusting the amount of current and generates the reference voltage using a current supplied from the current source.

10. A data line driving circuit for driving a plurality of data lines in an electro-optic device including pixels formed at intersections of a plurality of scanning lines and the plurality of data lines, and a scanning line driving circuit for sequentially selecting the plurality of scanning lines and supplying selection signals to the selected scanning lines, the data line driving circuit comprising:
a reference voltage generating means for generating a reference voltage to be used for generating a gray-scale current;
a gray-scale current generating means for generating a gray-scale current using the reference voltage generated by the reference voltage generating means;
a correction means for correcting the gray-scale current generated by the gray-scale current generating means;
a current-voltage converting means for generating a voltage according to the gray-scale current corrected by the correction means; and
a means for applying the voltage generated by the current-voltage converting means to the data lines.

11. An electro-optic device including a data line driving circuit according to claim 1.

12. An electronic apparatus including an electro-optic device according to claim 21.
